(19) United States
(12) Patent Application Publication
(10) Pub. No.: US 2001/0017577 A1
(43) Pub. Date: Aug. 30, 2001

(54) Variable phase shifter

(76) Inventors: Yasuo Toko, Tokyo (JP); Yasushi Iwakura, Tokyo (JP); Yoshihisa Iwamoto, Tokyo (JP); Masayuki Kanechika, Tokyo (JP); Keiichi Hirata, Tokyo (JP); Fumio Kubo, Tokyo (JP)

Correspondence Address: BIRCH STEWART KOLASCH & BIRCH, PO BOX 747, FALLS CHURCH, VA, 22040-0747, US

(21) Appl. No.: 09/788,450

(22) Filed: Feb. 21, 2001

(30) Foreign Application Priority Data
Feb. 21, 2000 (JP) NO.042103/2000

(51) Int. Cl. H01P 1/18

(52) U.S. Cl. 333/161; 333/156

(57) ABSTRACT

A variable phase shifter is improved in liquid crystal response characteristics by using a thin liquid crystal material as a dielectric substrate. The variable phase shifter includes two substrates disposed parallel to each other. The substrates have alignment layers on their mutually opposing inner surfaces. A liquid crystal layer is sealed in the area between the substrates. A transmission line is formed to meander on the inner surface of one of the substrates. A grounding conductor is formed on the inner surface of the substrate along the transmission line at a predetermined distance therefrom. External electrodes are formed at least in regions on the respective outer surfaces of the substrates, each of which regions corresponds to the gap between the transmission line and the grounding conductor. A bias voltage source applies a bias voltage between the upper and lower external electrodes.

### BACKGROUND OF THE INVENTION

1. Field of the Invention

The present invention relates to variable phase shifters for variably changing the phase of millimeter waves, microwaves, etc. More particularly, the present invention relates to a variable phase shifter using a liquid crystal as a dielectric substrate.

2. Discussion of Related Art

Applications of millimeter waves, microwaves and so forth are being actively developed these days. Regarding road traffic, for example, driving safety support systems have been developed in the field of advanced transportation systems known as “ITS (Intelligent Transport Systems)”. Such driving safety support systems use a millimeter-wave radar to acquire information about objects ahead of a running vehicle.

High-frequency devices used in the above-described systems include a variable phase shifter for variably changing the phase of a millimeter wave used. A known variable phase shifter is arranged as shown in FIG. 8 by way of example.

In FIG. 8, a variable phase shifter 1 is adapted to change the phase of a millimeter wave or a microwave. The variable phase shifter 1 has a dielectric substrate 2. A transmission line 3 is formed on the surface of the dielectric substrate 2. A glass plate 4 is placed over the transmission line 3 so as to cover the whole surface of the dielectric substrate 2. The variable phase shifter 1 further has a bias voltage source 5.

In FIG. 8, the dielectric substrate 2 has alignment layers 2a and 2b provided on both upper and lower surfaces thereof. A liquid crystal layer 2c is put between the alignment layers 2a and 2b, and a ground electrode 2d is placed in contact with the lower surface of the lower alignment layer 2b.

The alignment layers 2a and 2b have been subjected to alignment treatment in the directions of the double-headed arrow A by rubbing or other alignment technique.

The ground electrode 2d is connected to the negative electrode of the bias voltage source 5.

The liquid crystal layer 2c is filled with a nematic liquid crystal material, for example.

In the initial state (i.e. a state where no electric field is applied externally), the liquid crystal molecules in the liquid crystal layer 2c are aligned antiparallel in the direction of the arrow A owing to the alignment treatment performed on the alignment layers 2a and 2b.

The vertical thickness of the liquid crystal layer 2c is set at 50 micrometers, for example, in view of the dielectric constant of the liquid crystal layer 2c and the ease of alignment control of the liquid crystal molecules.

The transmission line 3 is disposed to meander on the upper surface of the dielectric substrate 2 in the form of a microstrip transmission line. A microwave is inputted to the transmission line 3 from one end 3a and outputted from the other end 3b. The transmission line 3 is connected to the positive electrode of the bias voltage source 5.

The direction of propagation of the microwave by the transmission line 3 is so selected as to be parallel to the initial alignment direction of the liquid crystal layer 2c.

The length and width of the transmission line 3 are set, for example, at 193 millimeters and 100 micrometers, respectively, so as to match the characteristic impedance of 50 Ω.

With the variable phase shifter 1 arranged as stated above, when a bias voltage is applied between the transmission line 3 and the ground electrode 2d from the bias voltage source 5, the orientation of the liquid crystal molecules in the liquid crystal layer 2c changes. That is, when the bias voltage is 0 V, the liquid crystal molecules are aligned perpendicular to the electric field of the microwave flowing along the transmission line 3. When a high bias voltage is applied between the transmission line 3 and the ground electrode 2d, the liquid crystal molecules are aligned parallel to the electric field of the microwave.

Thus, the dielectric constant ε of the liquid crystal layer 2c is changed by alignment control of the liquid crystal molecules in the liquid crystal layer 2c effected by controlling the bias voltage supplied from the bias voltage source 5. As the dielectric constant ε of the liquid crystal layer 2c changes, the phase of the microwave flowing along the transmission line 3 changes as shown in FIG. 9, for example, at 20 GHz, and the propagation velocity of the microwave along the transmission line 3 also changes.

However, in the conventional variable phase shifter 1 arranged as stated above, the thickness of the liquid crystal layer 2c is set at 50 micrometers in view of the dielectric constant of the liquid crystal layer 2c and the ease of alignment control of the liquid crystal molecules. This causes an undesired delay in response to the alignment control of the liquid crystal molecules in the liquid crystal layer 2c effected by controlling the bias voltage supplied from the bias voltage source 5.

### SUMMARY OF THE INVENTION

In view of the above-described circumstances, it is an object of the present invention to provide a variable phase shifter improved in liquid crystal response characteristics by using a thin liquid crystal material as a dielectric substrate.

According to a first aspect of the present invention, there is provided a variable phase shifter including two substrates disposed parallel to each other. The substrates have alignment layers on their mutually opposing inner surfaces. A liquid crystal layer is sealed in the area between the substrates. A transmission line is formed to meander on the inner surface of one of the two substrates. A grounding conductor is formed on the inner surface of the substrate along the transmission line at a predetermined distance therefrom. External electrodes are formed at least in regions on the respective outer surfaces of the substrates, each of which regions corresponds to the gap between the transmission line and the grounding conductor. The variable phase shifter further includes a bias voltage source for applying a bias voltage between the upper and lower external electrodes.

Preferably, the liquid crystal layer has a thickness in the range of from 0.5 to 3 micrometers.

It is even more desirable that the liquid crystal layer have a thickness in the range of from 1 to 2 micrometers.

Preferably, the gap between the transmission line and the grounding conductor has a width not less than 3 times the width of the transmission line.

In the variable phase shifter according to the first aspect of the present invention, a bias voltage from the bias voltage source is applied to the liquid crystal layer between the substrates through the external electrodes provided on the respective outer surfaces of the substrates. Consequently, the dielectric constant of the liquid crystal layer changes, causing a change to be introduced into the phase of a millimeter wave or a microwave flowing along the transmission line.

In this case, the bias voltage can be set as desired without taking into consideration the impedance of the transmission line. Accordingly, it becomes possible to reduce the thickness of the liquid crystal layer. For example, the liquid crystal layer may have a thickness in the range of from 0.5 to 3 micrometers. Consequently, the response of the liquid crystal improves, and it becomes possible to achieve high-speed phase change.

Further, both the transmission line and grounding conductor are formed on the inner surface of one substrate and there is a gap therebetween that has a width not less than 3 times the width of the transmission line, for example, about 50 to 200 micrometers. Therefore, it is possible to set a desired impedance for the transmission line by appropriately adjusting the width of the gap.

Thus, according to the present invention, the drive of the liquid crystal layer is controlled through the external electrodes, and the phase change of the microwave flowing along the transmission line is controlled by the distance between the transmission line and the grounding conductor. Therefore, the orientation change of the liquid crystal and the phase change of the microwave can be controlled independently of each other.

Accordingly, the variable phase shifter is capable of high-speed phase change and hence usable for high-speed phase modulation.

In the variable phase shifter according to the first aspect of the present invention, the grounding conductor preferably has a width of not less than 1 millimeter in a region between each pair of adjacent parallel sections of the meandering transmission line.

It is even more desirable that the grounding conductor have a width of not less than 3 millimeters in a region between each pair of adjacent parallel sections of the meandering transmission line.

If the grounding conductor has a width of not less than 1 millimeter, more preferably not less than 3 millimeters, the transmission line can be surely grounded.

Preferably, the grounding conductor has a wave-shaped air gap that passes only a high-frequency voltage.

If the grounding conductor has such an air gap, only the high-frequency voltage of a millimeter-wave or a microwave flowing from the transmission line to the grounding conductor passes through the air gap and is grounded. Thus, the high-frequency component can be removed.

According to a second aspect of the present invention, there is provided a variable phase shifter including two substrates disposed parallel to each other. The substrates have alignment layers on their mutually opposing inner surfaces. A liquid crystal layer is sealed in the area between the substrates. A transmission line is formed to meander on the inner surface of one of the two substrates to transmit a high-frequency signal and a liquid crystal driving signal. A grounding conductor is formed on the inner surface of the substrate along the transmission line at a predetermined distance therefrom. The variable phase shifter further includes a bias voltage source for applying a bias voltage between the transmission line and the grounding conductor.

In the variable phase shifter according to the second aspect of the present invention, a bias voltage from the bias voltage source is applied to the liquid crystal layer between the substrates through the transmission line and the grounding conductor. Consequently, the dielectric constant of the liquid crystal layer changes, causing a change to be introduced into the phase of a millimeter wave or a microwave flowing along the transmission line.

The above and other objects, features and advantages of the present invention will become more apparent from the following description of the preferred embodiments thereof, taken in conjunction with the accompanying drawing.

### BRIEF DESCRIPTION OF THE DRAWING

FIGS. 1(a) and 1(b) are schematic plan views showing the arrangement of an embodiment of the variable phase shifter according to the present invention, FIG. 1(a) showing the variable phase shifter before external electrodes are formed, FIG. 1(b) showing the variable phase shifter after the formation of external electrodes in a state where a grounding conductor is removed.

FIG. 2 is a vertical sectional view of the variable phase shifter taken along the line X-X in FIGS. 1(a) and l(b).

FIG. 3 is a vertical sectional view similar to FIG. 2, showing the variable phase shifter in a state where a bias voltage is applied.

FIG. 4 is a schematic sectional view showing an example of liquid crystal alignment in the variable phase shifter shown in FIGS. 1(a) and 1(b).

FIG. 5 is a schematic sectional view showing another example of liquid crystal alignment in the variable phase shifter shown in FIGS. 1(a) and 1(b).

FIG. 6 is a schematic plan view showing the arrangement of another embodiment of the variable phase shifter according to the present invention.

FIGS. 7(a) and 7(b) are vertical sectional views of the variable phase shifter according to the second embodiment taken along the line X-X in FIG. 6, FIG. 7(a) showing the variable phase shifter in a state where a bias voltage is not applied, FIG. 7(b) showing the variable phase shifter in a state where a bias voltage is applied.

FIG. 8 is a schematic perspective view showing the arrangement of a conventional variable phase shifter.

FIG. 9 is a graph showing the relationship between the bias voltage and the amount of phase change (phase shift) in the conventional variable phase shifter shown in FIG. 8.

### DETAILED DESCRIPTION OF THE PREFERRED EMBODIMENTS

Preferred embodiments of the present invention will be described below in detail with reference to the accompanying drawings.

Although various technically preferred limitations are added to the following embodiments because these are preferred specific examples of the present invention, it should be noted that the present invention is not limited by the embodiments, unless otherwise specified in the following description.

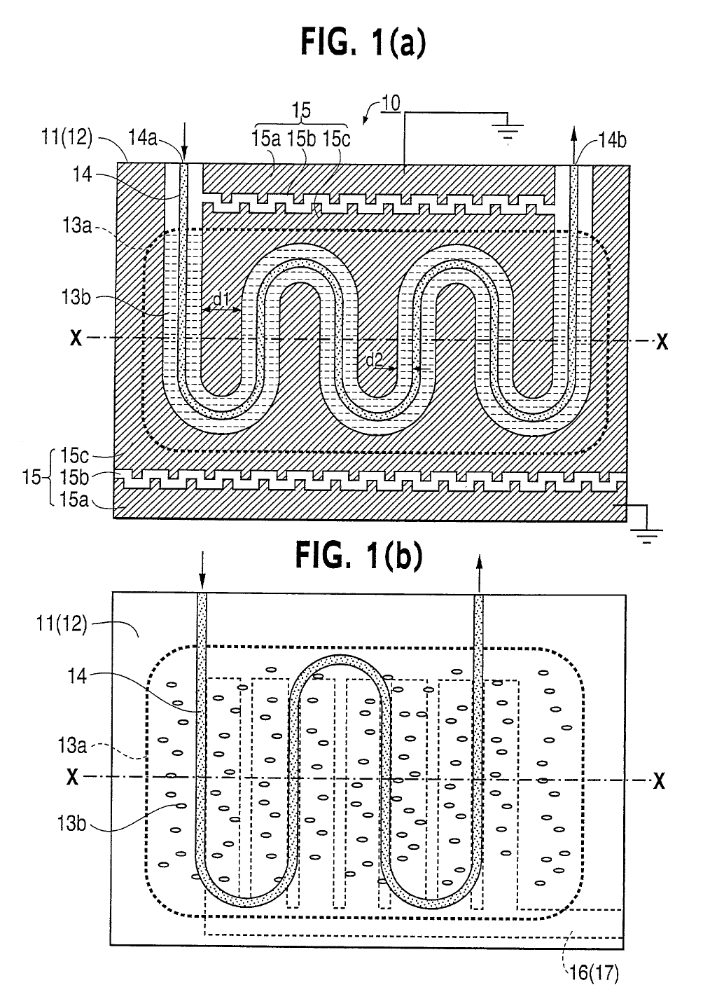

FIGS. 1(a) to 3 show the arrangement of an embodiment of the variable phase shifter according to the present invention.

In the figures, a variable phase shifter 10 is adapted to change the phase of a millimeter wave or a microwave. The variable phase shifter 10 has a two substrates 11 and 12 disposed parallel to each other. A liquid crystal layer 13 is sealed in the area between the substrates 11 and 12. A transmission line 14 and a grounding conductor 15 are formed on the inner (lower) surface of one substrate (upper substrate in the case of the illustrated example) 11. External electrodes 16 and 17 are formed on the respective outer surfaces of the substrates 11 and 12. A bias voltage source 18 is connected between the external electrodes 16 and 17.

The substrates 11 and 12 are made of quartz, ceramics, sapphire or glass, for example. The thickness of each of the substrates 11 and 12 is set at not less than 0.3 millimeters, preferably 0.6 millimeters.

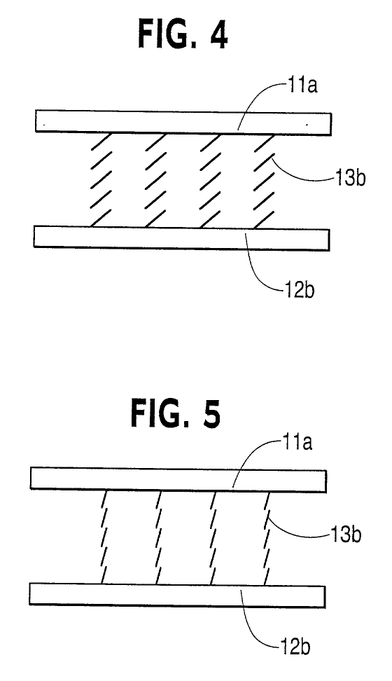

Further, the substrates 11 and 12 have alignment layers 11a and 12b on their mutually opposing inner surfaces (see FIG. 4).

The liquid crystal layer 13 is sandwiched between the substrates 11 and 12 and sealed at the periphery thereof with a sealing material 13a. The liquid crystal layer 13 is filled with a liquid crystal 13b. The thickness of the liquid crystal layer 13 is set at 0.5 to 3 micrometers, preferably 1 to 2 micrometers. To maintain the thickness of the liquid crystal layer 13, spacers 12a are interposed between the substrates 11 and 12.

The spacers 12a are made of glass, plastics or the like and have a predetermined outer diameter. It is preferable to selectively put the spacers 12a where the transmission line 14 and/or the grounding conductor 15 is formed. In this case, the outer diameter of the spacers 12a is set approximately equal to the difference between the thickness of the liquid crystal layer 13 and the thickness of the transmission line 14 (grounding conductor 15). It should be noted that when the thickness of the liquid crystal layer 13 and the thickness of the transmission line 14 (grounding conductor 15) are approximately equal to each other, the spacers 12a may be omitted.

As the liquid crystal 13b, a nematic liquid crystal material is used by way of example.

It should be noted that the alignment direction of the liquid crystal 13b is selected according to the type of liquid crystal 13b, for example, as stated below.

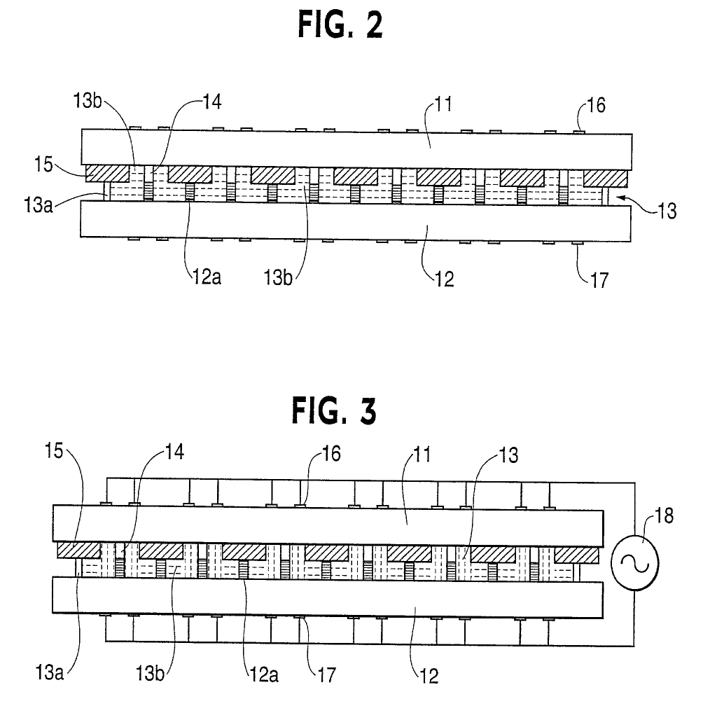

When the liquid crystal 13b is a nematic liquid crystal material with positive dielectric anisotropy Δε, the alignment layers 11a and 12b of the substrates 11 and 12 are rubbed in opposite (antiparallel) directions to each other so that the liquid crystal molecules are aligned antiparallel in the horizontal direction as viewed in FIG. 2.

The transmission line 14 is constructed to meander as illustrated in the figures by forming gold or a laminate of gold and copper on the inner (lower) surface of the upper substrate 11. The thickness of the transmission line 14 is set at not less than 0.5 micrometers, for example. The width of the transmission line 14 depends on the thickness of the substrate 11 and the dielectric constant ε.

The grounding conductor 15 is provided by forming gold, a laminate of gold and copper, or copper on the inner (lower) surface of the upper substrate 11 as in the case of the transmission line 14. The grounding conductor 15 is formed along each side of the transmission line 14 at a predetermined distance d2 from the transmission line 14.

Thus, the grounding conductor 15 is formed on each side of the transmission line 14 on the inner surface of the substrate 11.

It should be noted that the width d1 of the grounding conductor 15 in a region where it is sandwiched between two parallel sections of the meandering transmission line 14 at the right and left sides thereof as viewed in FIG. 1(a) is set at not less than 1 millimeter, preferably not less than 3 millimeters.

The thickness of the grounding conductor 15 is set at not less than 0.5 micrometers, for example. The distance d2 is selected in view of the impedance matching of the transmission line 14 and the transmission loss therein. Preferably, the distance d2 is set at about 50 to 200 micrometers.

It should be noted that the gap defined by the distance d2 is filled with the above-described liquid crystal 13b.

Furthermore, each grounding conductor 15 has a connecting portion 15a to be grounded to the outside at an edge of the substrate 11 (at each of the upper and lower edges of the substrate 11 as viewed in FIG. 1 (a)). The connecting portion 15a is cut off from a region 15c adjacent to the transmission line 14 by an air gap 15b.

In the case of the illustrated example, the air gap 15b has a square-wave shape. The width of the air gap 15b is set at about 100 micrometers, for example.

The external electrodes 16 and 17 are formed on the respective outer surfaces of the substrates 11 and 12 from a metal or ITO film. The thickness of the external electrodes 16 and 17 is not particularly restricted but may be selected appropriately.

It should be noted that, in the case of the illustrated example, the external electrodes 16 and 17 are formed in correspondence to the regions defined by the distance d2 between the transmission line 14 and the grounding conductor 15.

The bias voltage source 18 is a power source with a publicly known structure, which is arranged to apply a bias voltage between the external electrodes 16 and 17.

The bias voltage source 18 is adapted to drive the liquid crystal 13b with a bias voltage of 3 to 10 V at 100 to 10 kHz, for example.

The following is a description of the operation of the variable phase shifter 10 according to the embodiment of the present invention, arranged as stated above.

A microwave, for example, is inputted to the transmission line 14 from one end 14a thereof and outputted from the other end 14b.

At this time, an appropriate bias voltage is applied between the external electrodes 16 and 17 from the bias voltage source 18, whereby the liquid crystal 13b in the liquid crystal layer 13 is driven to change the orientation of the liquid crystal molecules. That is, when the bias voltage is 0 V, the direction of orientation of the liquid crystal molecules is horizontal (perpendicular to the electric field of the microwave) as shown in FIG. 2. When a high bias voltage is applied, the direction of orientation of the liquid crystal molecules becomes vertical (parallel to the electric field of the microwave) as shown in FIG. 3. Consequently, the dielectric constant ε of the liquid crystal layer 13 changes.

Because the transmission line 14 is separate from each grounding conductor 15 by the distance d2, the impedance of the transmission line 14 is set appropriately, and the transmission loss in the transmission line 14 is held down to a low level.

Accordingly, the spacing between the external electrodes 16 and 17 for applying a bias voltage to drive the liquid crystal 13b, that is, the thickness of the liquid crystal layer 13, need not be 50 micrometers as in the conventional variable phase shifter but may be set at 0.5 to 3 micrometers, for example, preferably 1 to 2 micrometers. This allows an improvement in response to the alignment control of the liquid crystal 13b effected by controlling the bias voltage.

Thus, the alignment control of the liquid crystal 13b is effected at high speed, and hence the dielectric constant is changed at high speed. Accordingly, the transmission line 14 changes in electrical length, although there is no change in the physical length of the transmission line 14. That is, the wavelength Λ_{g} on the substrate may be expressed by the following equation (1):

Λ_{g}=Λₒ/(εᵣₑ) (1)

where Λ_{g} is the wavelength on the substrate; Λₒ is the wavelength in free space; and εᵣₑ is an average dielectric constant in the substrate and free space.

Accordingly, as the dielectric constant changes, the wavelength Λ_{g} on the substrate also changes.

Thus, when the electrical length changes, a microwave that can be captured by the transmission line 14 changes. Consequently, the phase of the microwave outputted from the transmission line 14 can be changed.

The amount of phase change, that is, the amount of phase shift, can be changed by appropriately controlling the electrical length. Therefore, it is possible to change the amount of phase shift by appropriately selecting the material and thickness of the substrates 11 and 12 and the material of the liquid crystal 13b when the variable phase shifter 10 is designed.

In addition, the response of the liquid crystal 13b can be improved by reducing the thickness of the liquid crystal layer 13 and appropriately selecting the distance d2.

It should be noted that the distance d2 is selected in accordance with the dielectric constant of the substrates 11 and 12, the width of the transmission line 14 and so forth so that the transmission line 14 has a desired impedance. Specifically, it is preferable that the distance d2 be of the order of 50 to 200 micrometers, for example.

The width d1 of the grounding conductor 15 needs to be an appropriate distance so that the adjacent sections of the meandering transmission line 14 will not connect with each other. The width d1 is at least 1 millimeter, preferably 3 millimeters or more.

In a high-frequency region, e.g. a millimeter wave region or a microwave region, portions of the grounding conductor 15 on both sides of the air gap 15b, i.e. the connecting portion 15a and the region 15c, have the same electric potential. Therefore, in the high-frequency region, the region 15c can be regarded as effectively grounded.

In a low-frequency region such as that of a bias voltage for driving a liquid crystal, however, the connecting portion 15a and the region 15c have different electric potentials. Thus, the connecting portion 15a and the region 15c are substantially isolated from each other.

In this way, circuit separation takes place in the high-frequency region, so that the high-frequency voltage of a millimeter-wave or a microwave flowing along the transmission line 14 is prevented from driving the liquid crystal 13b between the external electrodes 16 and 17.

In the foregoing embodiment, the liquid crystal 13b is a nematic liquid crystal material with positive dielectric anisotropy Δε, for example, and the liquid crystal molecules are aligned antiparallel in the horizontal direction as viewed in FIG. 2. It should be noted, however, that the present invention is not necessarily limited thereto, and other liquid crystals, for example, those stated below, are also usable as the liquid crystal 13b.

In a second structural example, a nematic liquid crystal material with negative dielectric anisotropy Δε is usable as the liquid crystal 13b. In this case, the liquid crystal 13b is arranged so that the liquid crystal molecules are aligned antiparallel in the vertical direction as viewed in FIG. 2 (see FIG. 5). In this case, the vertical alignment is suitably effected by optical alignment using irradiation with polarized or non-polarized ultraviolet radiation, for example, because it is difficult to give a uniform pretilt angle by rubbing the alignment layers.

In a third structural example, a nematic liquid crystal material with positive or negative dielectric anisotropy Δε is used as the liquid crystal 13b. One alignment layer is treated to provide parallel alignment with a pretilt angle. The other alignment layer is treated to provide vertical alignment. Rubbing, optical alignment, etc. can be used as alignment treatment.

In a fourth structural example, a ferroelectric liquid crystal (FLC) material having the SmC* phase is used as the liquid crystal 13b. In general, a surface-stabilized FLC material is usable by way of example. One alignment layer is treated to provide parallel alignment.

Further, antiferroelectric liquid crystal (AFLC) materials and liquid crystal materials having the SmA phase are also usable as the liquid crystal 13b.

In the case of AFLC materials, an electrically induced phase transition AFLC material utilizing electrically induced phase transition between the SmC*_{A} phase and the SmC* phase is usable by way of example.

In the case of a liquid crystal material having the SmA phase, a molecular orientation change caused by electroclinic effect is utilized.

Accordingly, any liquid crystal material is usable as the liquid crystal 13b, provided that the molecular orientation changes in response to appropriate control of the bias voltage supplied from the bias voltage source 18. It is preferable to use a liquid crystal material providing a large amount of molecular orientation change Δn.

In the foregoing embodiment, the external electrodes 16 and 17 are formed on the respective outer surfaces of the substrates 11 and 12 in correspondence to the regions defined by the distance d2 between the transmission line 14 and the grounding conductor 15. However, the present invention is not necessarily limited to the described arrangement. The external electrodes 16 and 17 may be formed all over the respective outer surfaces of the substrates 11 and 12.

Furthermore, in the foregoing embodiment, the transmission line 14 and the grounding conductor 15 are formed on the inner (lower) surface of the upper substrate 11. However, the present invention is not necessarily limited the described arrangement. It will be apparent that the transmission line 14 and the grounding conductor 15 may be formed on the inner (upper) surface of the lower substrate 12.

Furthermore, although in the foregoing embodiment a microwave is inputted to the transmission line 14, it should be noted that the present invention is not necessarily limited thereto, and that a millimeter wave may be inputted to the transmission line 14. In this case also, the phase of the millimeter wave can be changed.

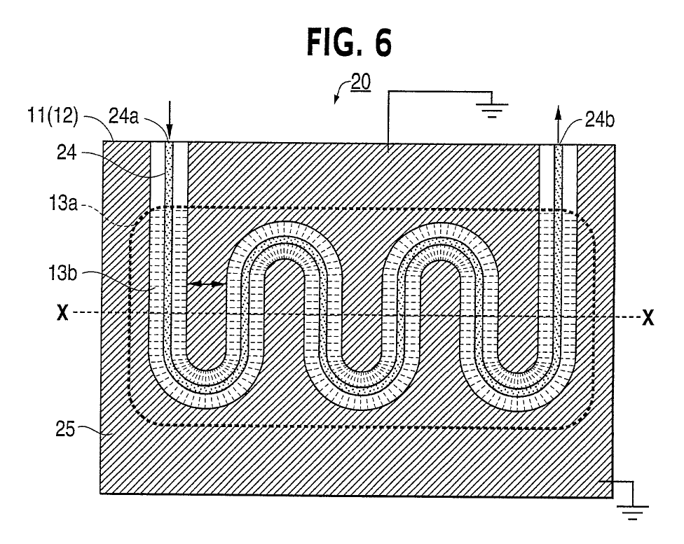

FIG. 6 shows the arrangement of another embodiment of the variable phase shifter according to the present invention.

In FIG. 6, a variable phase shifter 20 is adapted to change the phase of a millimeter wave or a microwave. The variable phase shifter 20 has a two substrates 11 and 12 disposed parallel to each other. A liquid crystal layer 13 is sealed in the area between the substrates 11 and 12. A transmission line 24 and a grounding conductor 25 are formed on the inner (lower) surface of one substrate (upper substrate in the case of the illustrated example)

In this embodiment, no external electrodes are formed, although in the foregoing embodiment external electrodes are formed on the respective outer surfaces of the substrates 11 and 12.

In the variable phase shifter 20 according to this embodiment of the present invention, a high-frequency wave, e.g. a microwave, and an alternating-current (AC) signal for driving the liquid crystal are inputted to the transmission line 24 from one end 24a thereof and outputted from the other end 24b. When the liquid crystal driving AC signal is inputted to the transmission line 24, an appropriate bias voltage is applied between the grounding conductor 25 and the transmission line 24, whereby the liquid crystal molecules 13b in the liquid crystal layer 13 are driven.

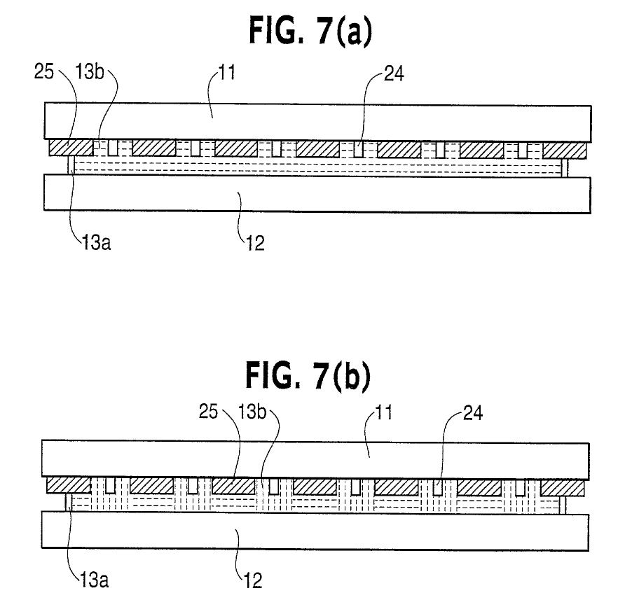

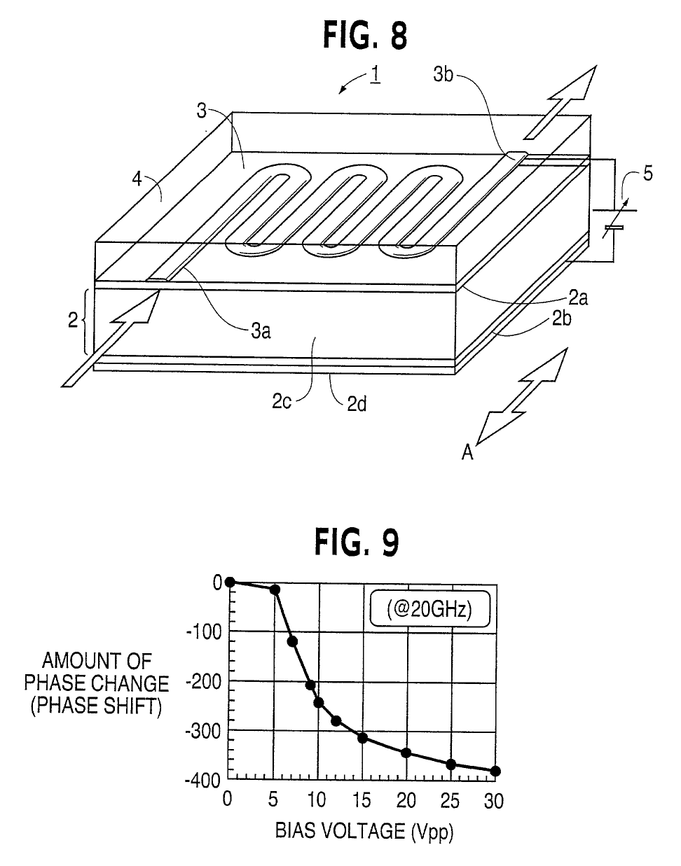

In a case where a liquid crystal material with negative dielectric anisotropy (Δε<0) is used as the liquid crystal 13b in the liquid crystal layer 13, when the bias voltage is 0 V, the liquid crystal molecules are aligned perpendicular to the direction of the longitudinal axis of the transmission line 24 (parallel to the substrates 11 and 12) as shown in FIGS. 6 and 7(a). When a high bias voltage is applied, the liquid crystal molecules are aligned parallel to the direction of the longitudinal axis of the transmission line 24 (parallel to the substrates 11 and 12) as shown in FIG. 7(b). Consequently, the dielectric constant ε of the liquid crystal layer 13 changes.

It should be noted that the above-described molecular alignment in which the liquid crystal molecules are aligned perpendicular to the direction of the longitudinal axis of the transmission line 24 includes not only an alignment in which liquid crystal molecules are exactly at right angles to the direction of the longitudinal axis of the transmission line 24 but also an alignment in which liquid crystal molecules are inclined at less than 45 degrees from the position exactly perpendicular to the longitudinal axis direction of the transmission line 24. If the liquid crystal molecules 13b are exactly perpendicular (90 degrees) to the longitudinal axis direction of the transmission line 24 under application of no voltage, the direction of tilt of the liquid crystal molecules 13b is not stabilized when a bias voltage is applied. Therefore, it is preferable to align the liquid crystal molecules 13b at an angle of 2 to 5 degrees to the longitudinal axis direction of the transmission line 24. It should be noted that the above-described molecular alignment in which the liquid crystal molecules are aligned parallel to the direction of the longitudinal axis of the transmission line 24 includes not only an alignment in which liquid crystal molecules are exactly parallel to the direction of the longitudinal axis of the transmission line 24 but also an alignment in which liquid crystal molecules are inclined at less than 45 degrees from the position exactly parallel to the longitudinal axis direction of the transmission line 24.

In the foregoing embodiment, the liquid crystal layer is driven by switching effected in the direction of thickness of the layer between a pair of substrates through the external electrodes 16 and 17, whereas in this embodiment, switching is performed in the transverse direction, as stated above. Accordingly, it becomes possible to reduce the thickness of the liquid crystal layer and hence possible to achieve high-speed phase change as in the case of the foregoing embodiment.

It should be noted that a high-frequency signal in the GHz frequency band and a liquid crystal driving AC signal in the frequency range of several hundred Hz to several kHz, for example, are used as signals to be inputted to the transmission line 24. When the distance d2 between the grounding conductor 25 and the transmission line 24 is long, the threshold voltage becomes high. In such a case, it is preferable to apply not a low voltage of about 5 V but a high voltage of up to about several hundred V as a liquid crystal driving voltage. The thickness of the liquid crystal layer is preferably set at not more than 30 micrometers, even more preferably not more than 10 micrometers. By doing so, the response time can be reduced favorably.

Although in the second embodiment a liquid crystal material with negative dielectric anisotropy is used as the liquid crystal 13b in the liquid crystal layer 13, a liquid crystal material with positive dielectric anisotropy (Δε>0) is also usable. In this case, when the bias voltage is 0 V, the liquid crystal molecules are aligned parallel to the direction of the longitudinal axis of the transmission line 24 (parallel to the substrates 11 and 12). When a high bias voltage is applied, the liquid crystal molecules are aligned perpendicular to the direction of the longitudinal axis of the transmission line 24 (parallel to the substrates 11 and 12). Consequently, the dielectric constant ε of the liquid crystal layer 13 changes. Thus, the phase of the input microwave or other high-frequency wave is changed, and the phase-shifted wave is outputted.

As has been detailed above, the present invention provides advantageous effects as stated below.

In the case of the variable phase shifter according to the present invention that is formed with external electrodes, a bias voltage from the bias voltage source is applied to the liquid crystal layer between the substrates through the external electrodes provided on the respective outer surfaces of the substrates. Therefore, the bias voltage can be set as desired without taking into consideration the impedance of the transmission line. Accordingly, it becomes possible to reduce the thickness of the liquid crystal layer. Consequently, the response of the liquid crystal improves, and it becomes possible to achieve high-speed phase change.

Further, both the transmission line and grounding conductor are formed on the inner surface of one substrate and there is a gap therebetween that has a width not less than 3 times the width of the transmission line. Therefore, it is possible to set a desired impedance for the transmission line by appropriately adjusting the width of the gap.

In the case of the variable phase shifter according to the present invention that is not formed with external electrodes, a bias voltage from the bias voltage source is applied to the liquid crystal layer between the substrates through the transmission line and the grounding conductor. Therefore, the liquid crystal layer can be driven by switching effected in the transverse direction, which is parallel to the substrates. Accordingly, it is possible to reduce the thickness of the liquid crystal layer. Consequently, the response of the liquid crystal improves, and it becomes possible to achieve high-speed phase change.

Thus, the present invention provides an extremely superior variable phase shifter improved in liquid crystal response characteristics by using a thin liquid crystal material as a dielectric substrate.

It should be noted that the present invention is not necessarily limited to the foregoing embodiments but can be modified in a variety of ways without departing from the gist of the present invention.

What is claimed is:

1. A variable phase shifter comprising:
two substrates disposed parallel to each other, said substrates having alignment layers on their mutually opposing inner surfaces;
a liquid crystal layer sealed in an area between said two substrates;
a transmission line formed to meander on the inner surface of one of said two substrates;
a grounding conductor formed on the inner surface of the one of said two substrates along said transmission line at a predetermined distance from said transmission line;
external electrodes formed at least in regions on respective outer surfaces of said two substrates, said regions each corresponding to a gap between said transmission line and said grounding conductor; and
a bias voltage source for applying a bias voltage between said external electrodes.

2. A variable phase shifter according to claim 1, wherein said liquid crystal layer has a thickness in a range of from 0.5 micrometers to 3 micrometers.

3. A variable phase shifter according to claim 1, wherein the gap between said transmission line and said grounding conductor has a width not less than 3 times a width of said transmission line.

4. A variable phase shifter according to claim 1, wherein said grounding conductor has a width of not less than 1 millimeter in a region between each pair of adjacent parallel sections of the meandering transmission line.

5. A variable phase shifter according to claim 1, wherein said grounding conductor has a width of not less than 3 millimeters in a region between each pair of adjacent parallel sections of the meandering transmission line.

6. A variable phase shifter according to claim 1, wherein said grounding conductor has a wave-shaped air gap that passes only a high-frequency voltage.

7. A variable phase shifter comprising:
two substrates disposed parallel to each other, said substrates having alignment layers on their mutually opposing inner surfaces;
a liquid crystal layer sealed in an area between said two substrates;
a transmission line formed to meander on the inner surface of one of said two substrates to transmit a high-frequency signal and a liquid crystal driving signal;
a grounding conductor formed on the inner surface of the one of said two substrates along said transmission line at a predetermined distance from said transmission line; and
a bias voltage source for applying a bias voltage between said transmission line and said grounding conductor.
